(19) United States
(12) Patent Application Publication
(10) Pub. No.: US 2025/0374189 A1
(43) Pub. Date: Dec. 4, 2025

(54) METHOD AND DEVICE FOR LOW POWER OPERATION IN WIRELESS LAN SUPPORTING MLSR OPERATION

(71) Applicants: HYUNDAI MOTOR COMPANY, Seoul (KR); KIA CORPORATION, Seoul (KR); Korea National University of Transportation Industry-Academic Cooperation Foundation, Chungju-si, Chungcheongbuk-do (KR)

(72) Inventors: Yong Ho Kim, Incheon (KR); Ju Seong Moon, Osan-si, Gyeonggi-do (KR)

(73) Assignees: HYUNDAI MOTOR COMPANY, Seoul (KR); KIA CORPORATION, Seoul (KR); Korea National University of Transportation Industry-Academic Cooperation Foundation, Chungju-si, Chungcheongbuk-do (KR)

(21) Appl. No.: 18/874,743

(22) PCT Filed: Aug. 23, 2023
(86) PCT No.: PCT/KR2023/012497

§ 371 Date: Dec. 13, 2024

(30) Foreign Application Priority Data
Aug. 24, 2022 (KR) 10-2022-0105984
Mar. 2, 2023 (KR) 10-2023-0028098

(51) Int. Cl. H04W 52/02; H04W 76/15

(52) U.S. Cl. CPC H04W 52/0235; H04W 52/0216; H04W 76/15

(57) ABSTRACT

A method and a device for low power operation in a wireless LAN supporting an MLSR operation are disclosed. The method of an STA MLD comprises steps in which: a power saving operation is performed in a first link and a second link; a first STA receives a beacon frame from a first AP associated with an AP MLD while the first STA associated with the STA MLD operates in an awake state in the first link; the first STA performs first communication with the first AP in the first link on the basis of the beacon frame; and, after completion of the first communication, a second STA performs second communication with a second AP associated with the AP MLD while the second STA associated with the STA MLD operates in the awake state in the second link.

### TECHNICAL FIELD

The present disclosure relates to a wireless local area network (LAN) communication technique, and more particularly, to a technique for low-power communication in a wireless LAN supporting multi-link single radio (MLSR) or enhanced MLSR (EMLSR) operations.

### BACKGROUND ART

Recently, as the spread of mobile devices expands, a wireless local area network technology capable of providing fast wireless communication services to mobile devices is in the spotlight. The wireless LAN technology may be a technology that supports mobile devices such as smart phones, smart pads, laptop computers, portable multimedia players, embedded devices, and the like to wirelessly access the Internet based on wireless communication technology.

The standards that use wireless LAN technology are mainly developed as the Institute of Electrical and Electronics Engineers (IEEE) 802.11 standards. As the aforementioned wireless LAN technology has been developed and widely adopted, applications utilizing wireless LAN technology have diversified, and demand has arisen for wireless LAN technology that supports a higher throughput. In a wireless LAN, a device can perform communication on multiple links. When a device operates on multiple links, its power consumption may increase. Therefore, low-power communication techniques for the device operating on multiple links may be required.

Meanwhile, the technologies that are the background of the present disclosure are written to improve the understanding of the background of the present disclosure and may include content that is not already known to those of ordinary skill in the art to which the present disclosure belongs.

### DISCLOSURE

### Technical Problem

The present disclosure is directed to providing a method and an apparatus for low-power communication in a wireless LAN supporting multi-link single radio (MLSR) or enhanced MLSR (EMLSR) operations.

### Technical Solution

A method of a station (STA) multi-link device (MLD), according to exemplary embodiments of the present disclosure for achieving the above-described objective, may comprise: performing a power-saving operation on a first link and a second link; receiving a beacon frame from a first access point (AP) affiliated with an AP MLD while a first STA affiliated with the STA MLD operates in an awake state on the first link; performing, by the first STA, first communication with the first AP on the first link based on the beacon frame; and performing, by a second STA affiliated with the STA MLD, second communication with a second AP affiliated the AP MLD while the second STA affiliated with the STA MLD operates in the awake state on the second link after the first communication is completed.

The method may further comprise: transmitting, to the AP MLD, a first frame including information indicating that the power-saving operation is performed on the first link and information indicating that the power-saving operation is performed on the second link, on one of the first link and the second link.

The first frame may further include information indicating a level of the power-saving operation, an operation state of each of the first STA and the second STA may be the awake state or the doze state when a first level of the power-saving operation is supported, and the operation state of each of the first STA and the second STA may be the awake state or a deep sleep state when a second level of the power-saving operation is supported.

A level of the power-saving operation performed on the first link may be different from a level of the power-saving operation performed on the second link.

The operation state of the first STA on the first link may be synchronized with the operation state of the second STA on the second link.

The performing of the first communication may comprise: transmitting, by the first STA, a power-saving (PS)-Poll frame for the beacon frame to the first AP on the first link; receiving, by the first STA, an initial control frame from the first AP on the first link; transmitting, by the first STA, a response frame for the initial control frame to the first AP on the first link; and receiving, by the first STA, a data frame from the first AP on the first link.

In order to receive the initial control frame, the first STA may perform a listening operation on the first link, and the second STA may perform a listening operation on the second link.

The performing of the first communication may comprise: transmitting, by the first STA, a PS-Poll frame for the beacon frame to the first AP on the first link; and receiving, by the first STA, a data frame from the first AP without receiving an initial control frame on the first link.

The PS-Poll frame may include information indicating an operation state of the first STA on the first link and information indicating an operation state of the second STA on the second link.

The performing of the second communication may comprise: receiving, by the second STA, an initial control frame from the second AP on the second link; transmitting, by the second STA, a response frame for the initial control frame to the second AP on the second link; and receiving, by the second STA, a data frame from the second AP on the second link.

The performing of the second communication may comprise: transmitting, by the second STA, a PS-Poll frame to the second AP on the second link; and receiving, by the second STA, a data frame from the second AP without receiving an initial control frame on the second link.

A STA MLD, according to exemplary embodiments of the present disclosure for achieving the above-described objective, may comprise: a processor, wherein the processor may cause the STA MLD to perform: performing a power-saving operation on a first link and a second link; receiving a beacon frame from a first access point (AP) affiliated with an AP MLD while a first STA affiliated with the STA MLD operates in an awake state on the first link; performing, by the first STA, first communication with the first AP on the first link based on the beacon frame; and performing, by a second STA affiliated with the STA MLD, second communication with a second AP affiliated the AP MLD while the second STA affiliated with the STA MLD operates in the awake state on the second link after the first communication is completed.

The processor may further cause the STA MLD to perform: transmitting, to the AP MLD, a first frame including information indicating that the power-saving operation is performed on the first link and information indicating that the power-saving operation is performed on the second link, on one of the first link and the second link.

The first frame may further include information indicating a level of the power-saving operation, an operation state of each of the first STA and the second STA may be the awake state or the doze state when a first level of the power-saving operation is supported, and the operation state of each of the first STA and the second STA may be the awake state or a deep sleep state when a second level of the power-saving operation is supported.

A level of the power-saving operation performed on the first link may be different from a level of the power-saving operation performed on the second link.

In the performing of the first communication, the processor may cause the STA MLD to perform: transmitting, by the first STA, a power-saving (PS)-Poll frame for the beacon frame to the first AP on the first link; receiving, by the first STA, an initial control frame from the first AP on the first link; transmitting, by the first STA, a response frame for the initial control frame to the first AP on the first link; and receiving, by the first STA, a data frame from the first AP on the first link.

In the performing of the first communication, the processor may cause the STA MLD to perform: transmitting, by the first STA, a PS-Poll frame for the beacon frame to the first AP on the first link; and receiving, by the first STA, a data frame from the first AP without receiving an initial control frame on the first link.

The PS-Poll frame may include information indicating an operation state of the first STA on the first link and information indicating an operation state of the second STA on the second link.

In the performing of the second communication, the processor may cause the STA MLD to perform: receiving, by the second STA, an initial control frame from the second AP on the second link; transmitting, by the second STA, a response frame for the initial control frame to the second AP on the second link; and receiving, by the second STA, a data frame from the second AP on the second link.

In the performing of the second communication, the processor may cause the STA MLD to perform: transmitting, by the second STA, a PS-Poll frame to the second AP on the second link; and receiving, by the second STA, a data frame from the second AP without receiving an initial control frame on the second link.

### Advantageous Effects

According to the present disclosure, a device (e.g., multi-link device (MLD), station (STA), or access point (AP)) can perform power-saving operations on multiple links. For example, each STA affiliated with a STA MLD can operate in an awake state or a doze state. A STA operating in the awake state may communicate with an AP, while a STA operating in the doze state may not communicate with an AP. Through this power-saving operation, the power consumption of the STA MLD can be reduced.

### DESCRIPTION OF DRAWINGS

FIG. 1 is a block diagram illustrating a first exemplary embodiment of a communication node constituting a wireless LAN system.

FIG. 2 is a conceptual diagram illustrating a first exemplary embodiment of a multi-link configured between multi-link devices (MLDs).

FIG. 3A is a timing diagram illustrating a first exemplary embodiment of a method for configuring a power-saving operation in a wireless LAN supporting EMLSR operation.

FIG. 3B is a timing diagram illustrating a second exemplary embodiment of a method for configuring a power-saving operation in a wireless LAN supporting EMLSR operation.

FIG. 4A is a timing diagram illustrating a first exemplary embodiment of a downlink communication method during a power-saving operation of an EMLSR MLD.

FIG. 4B is a timing diagram illustrating a second exemplary embodiment of a downlink communication method during a power-saving operation of an EMLSR MLD.

FIG. 5A is a timing diagram illustrating a third exemplary embodiment of a downlink communication method during a power-saving operation of an EMLSR MLD.

FIG. 5B is a timing diagram illustrating a fourth exemplary embodiment of a downlink communication method during a power-saving operation of an EMLSR MLD.

FIG. 6A is a timing diagram illustrating a first exemplary embodiment of a power-saving operation of an EMLSR MLD.

FIG. 6B is a timing diagram illustrating a second exemplary embodiment of a power-saving operation of an EMLSR MLD.

FIG. 6C is a timing diagram illustrating a third exemplary embodiment of a power-saving operation of an EMLSR MLD.

### MODE FOR INVENTION

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

The terms used in the present disclosure are only used to describe specific exemplary embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

Hereinafter, forms of the present disclosure will be described in detail with reference to the accompanying drawings. In describing the disclosure, to facilitate the entire understanding of the disclosure, like numbers refer to like elements throughout the description of the figures and the repetitive description thereof will be omitted.

In the following, a wireless communication system to which exemplary embodiments according to the present disclosure are applied will be described. The wireless communication system to which the exemplary embodiments according to the present disclosure are applied is not limited to the contents described below, and the exemplary embodiments according to the present disclosure can be applied to various wireless communication systems. A wireless communication system may be referred to as a ‘wireless communication network’.

In exemplary embodiments, ‘configuration of an operation (e.g., transmission operation)’ may mean that ‘configuration information (e.g., information element(s), parameter(s)) for the operation’ and/or ‘information indicating to perform the operation’ is signaled. ‘Configuration of an information element (e.g., parameter)’ may mean that the information element is signaled. ‘Configuration of a resource (e.g., resource region)’ may mean that setting information of the resource is signaled.

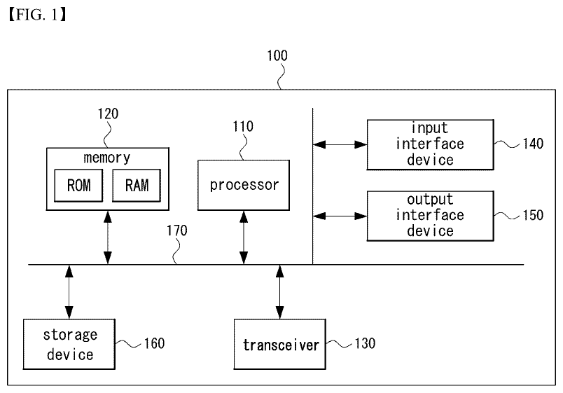

FIG. 1 is a block diagram illustrating a first exemplary embodiment of a communication node constituting a wireless LAN system.

As shown in FIG. 1, a communication node 100 may be an access point, a station, an access point (AP) multi-link device (MLD), or a non-AP MLD. An access point may refer to ‘AP’, and a station may refer to ‘STA’ or ‘non-AP STA’. An operating channel width supported by an AP may be 20 megahertz (MHz), 80 MHz, 160 MHz, or the like. An operating channel width supported by a STA may be 20 MHz, 80 MHz, or the like.

The communication node 100 may include at least one processor 110, a memory 120, and a transceiver 130 connected to a network to perform communications. The transceiver 130 may be referred to as a transceiver, a radio frequency (RF) unit, an RF module, or the like. In addition, the communication node 100 may further include an input interface device 140, an output interface device 150, a storage device 160, and the like. The respective components included in the communication node 100 may be connected by a bus 170 to communicate with each other.

However, the respective components included in the communication node 100 may be connected through individual interfaces or individual buses centering on the processor 110 instead of the common bus 170. For example, the processor 110 may be connected to at least one of the memory 120, the transceiver 130, the input interface device 140, the output interface device 150, and the storage device 160 through a dedicated interface.

The processor 110 may execute program commands stored in at least one of the memory 120 and the storage device 160. The processor 110 may refer to a central processing unit (CPU), a graphics processing unit (GPU), or a dedicated processor on which the methods according to the exemplary embodiments of the present disclosure are performed. Each of the memory 120 and the storage device 160 may be configured as at least one of a volatile storage medium and a nonvolatile storage medium. For example, the memory 120 may be configured with at least one of a read only memory (ROM) and a random access memory (RAM).

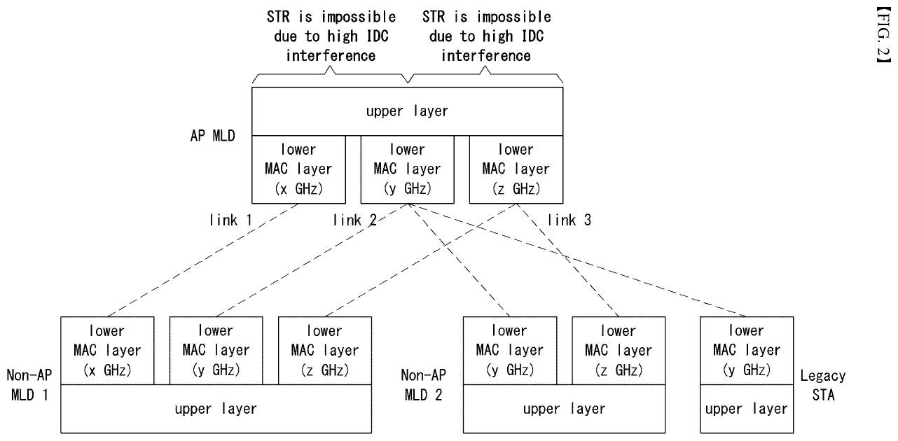

FIG. 2 is a conceptual diagram illustrating a first exemplary embodiment of a multi-link configured between multi-link devices (MLDs).

As shown in FIG. 2, an MLD may have one medium access control (MAC) address. In exemplary embodiments, the MLD may mean an AP MLD and/or non-AP MLD. The MAC address of the MLD may be used in a multi-link setup procedure between the non-AP MLD and the AP MLD. The MAC address of the AP MLD may be different from the MAC address of the non-AP MLD. AP(s) affiliated with the AP MLD may have different MAC addresses, and station(s) affiliated with the non-AP MLD may have different MAC addresses. Each of the APs having different MAC addresses within the AP MLD may be in charge of each link, and may perform a role of an independent AP.

Each of the STAs having different MAC addresses within the non-AP MLD may be in charge of each link, and may perform a role of an independent STA. The non-AP MLD may be referred to as a STA MLD. The MLD may support a simultaneous transmit and receive (STR) operation. In this case, the MLD may perform a transmission operation in a link 1 and may perform a reception operation in a link 2. The MLD supporting the STR operation may be referred to as an STR MLD (e.g., STR AP MLD, STR non-AP MLD). In exemplary embodiments, a link may mean a channel or a band. A device that does not support the STR operation may be referred to as a non-STR (NSTR) AP MLD or an NSTR non-AP MLD (or NSTR STA MLD).

The MLD may transmit and receive frames in multiple links by using a non-contiguous bandwidth extension scheme (e.g., 80 MHz+80 MHz). The multi-link operation may include multi-band transmission. The AP MLD may include a plurality of APs, and the plurality of APs may operate in different links. Each of the plurality of APs may perform function(s) of a lower MAC layer. Each of the plurality of APs may be referred to as a ‘communication node’ or ‘lower entity’. The communication node (i.e., AP) may operate under control of an upper layer (or the processor 110 shown in FIG. 1). The non-AP MLD may include a plurality of STAs, and the plurality of STAs may operate in different links. Each of the plurality of STAs may be referred to as a ‘communication node’ or ‘lower entity’. The communication node (i.e., STA) may operate under control of an upper layer (or the processor 110 shown in FIG. 1).

The MLD may perform communications in multiple bands (i.e., multi-band). For example, the MLD may perform communications using an 80 MHz bandwidth according to a channel expansion scheme (e.g., bandwidth expansion scheme) in a 2.4 GHz band, and perform communications using a 160 MHz bandwidth according to a channel expansion scheme in a 5 GHz band. The MLD may perform communications using a 160 MHz bandwidth in the 5 GHz band, and may perform communications using a 160 MHz bandwidth in a 6 GHz band. One frequency band (e.g., one channel) used by the MLD may be defined as one link. Alternatively, a plurality of links may be configured in one frequency band used by the MLD. For example, the MLD may configure one link in the 2.4 GHz band and two links in the 6 GHz band. The respective links may be referred to as a first link, a second link, and a third link. Alternatively, each link may be referred to as a link 1, a link 2, a link 3, or the like. A link number may be set by an access point, and an identifier (ID) may be assigned to each link.

The MLD (e.g., AP MLD and/or non-AP MLD) may configure a multi-link by performing an access procedure and/or a negotiation procedure for a multi-link operation. In this case, the number of links and/or link(s) to be used in the multi-link may be configured. The non-AP MLD (e.g., STA) may identify information on band(s) capable of communicating with the AP MLD. In the negotiation procedure for a multi-link operation between the non-AP MLD and the AP MLD, the non-AP MLD may configure one or more links among links supported by the AP MLD to be used for the multi-link operation. A station that does not support a multi-link operation (e.g., IEEE 802.11a/b/g/n/ac/ax STA) may be connected to one or more links of the multi-link supported by the AP MLD.

When a band separation between multiple links (e.g., a band separation between a link 1 and a link 2 in the frequency domain) is sufficient, the MLD may be able to perform an STR operation. For example, the MLD may transmit a physical layer convergence procedure (PLCP) protocol data unit (PPDU) 1 using the link 1 among multiple links, and may receive a PPDU 2 using the link 2 among multiple links. On the other hand, if the MLD performs an STR operation when the band separation between multiple links is not sufficient, in-device coexistence (IDC) interference, which is interference between the multiple links, may occur. Accordingly, when the bandwidth separation between multiple links is not sufficient, the MLD may not be able to perform an STR operation. A link pair having the above-described interference relationship may be a non-simultaneous transmit and receive (NSTR)-limited link pair. Here, the MLD may be referred to as ‘NSTR AP MLD’ or ‘NSTR non-AP MLD’.

For example, a multi-link including a link 1, a link 2, and a link 3 may be configured between an AP MLD and a non-AP MLD 1. When a band separation between the link 1 and the link 3 is sufficient, the AP MLD may perform an STR operation using the link 1 and the link 3. That is, the AP MLD may transmit a frame using the link 1 and receive a frame using the link 3. When a band separation between the link 1 and the link 2 is insufficient, the AP MLD may not be able to perform an STR operation using the link 1 and the link 2. When a band separation between the link 2 and the link 3 is not sufficient, the AP MLD may not be able to perform an STR operation using the link 2 and the link 3.

Meanwhile, in a wireless LAN system, a negotiation procedure for a multi-link operation may be performed in an access procedure between a station and an access point. A device (e.g., access point, station) that supports multiple links may be referred to as ‘multi-link device (MLD)’. An access point supporting multiple links may be referred to as ‘AP MLD’, and a station supporting multiple links may be referred to as ‘non-AP MLD’ or ‘STA MLD’. The AP MLD may have a physical address (e.g., MAC address) for each link. The AP MLD may be implemented as if an AP in charge of each link exists separately. A plurality of APs may be managed within one AP MLD. Therefore, coordination between a plurality of APs belonging to the same AP MLD may be possible. A STA MLD may have a physical address (e.g., MAC address) for each link. The STA MLD may be implemented as if a STA in charge of each link exists separately. A plurality of STAs may be managed within one STA MLD. Therefore, coordination between a plurality of STAs belonging to the same STA MLD may be possible.

For example, an AP1 of the AP MLD and a STA1 of the STA MLD may each be responsible for a first link and perform communication using the first link. An AP2 of the AP MLD and a STA2 of the STA MLD may each be responsible for a second link and perform communication using the second link. The STA2 may receive status change information for the first link on the second link. In this case, the STA MLD may collect information (e.g., status change information) received on the respective links, and control operations performed by the STA1 based on the collected information.

Hereinafter, data transmission and reception methods in a wireless LAN system will be described. Even when a method (e.g., transmission or reception of a signal) performed at a first communication node among communication nodes is described, a corresponding second communication node may perform a method (e.g., reception or transmission of the signal) corresponding to the method performed at the first communication node. That is, when an operation of a STA is described, an AP corresponding thereto may perform an operation corresponding to the operation of the STA. Conversely, when an operation of an AP is described, a STA corresponding thereto may perform an operation corresponding to the operation of the AP.

In exemplary embodiments, operations of a STA may be interpreted as operations of a STA MLD, operations of a STA MLD may be interpreted as operations of a STA, operations of an AP may be interpreted as operations of an AP MLD, and operations of an AP MLD may be interpreted as operations of an AP. A STA of a STA MLD may refer to a STA affiliated with the STA MLD, and an AP of an AP MLD may refer to an AP affiliated with the AP MLD. When a STA MLD includes a first STA operating on a first link and a second STA operating on a second link, operations of the STA MLD on the first link may be interpreted as operations of the first STA, and operations of the STA MLD on the second link may be interpreted as operations of the second STA. When an AP MLD includes a first AP operating on the first link and a second AP operating on the second link, operations of the AP MLD on the first link may be interpreted as operations of the first AP, and operations of the AP MLD on the second link may be interpreted as operations of the second AP. In exemplary embodiments, a transmission time of a frame may refer to a transmission start time or a transmission end time, and a reception time of a frame may refer to a reception start time or a reception end time. A transmission time may be interpreted as corresponding to a reception time. A time point may be interpreted as a time, and a time may be interpreted as a time point.

Meanwhile, a low-power operation for a multi-link single radio (MLSR) MLD or enhanced MLSR (EMLSR) MLD operating on multiple links may be defined. In the present disclosure, an operation of an MLSR MLD may be interpreted as an operation of an EMLSR MLD, an operation of an EMLSR MLD may be interpreted as an operation of an MLSR MLD, and a low-power operation may refer to a power-saving operation.

A STA MLD may support MLSR operation or EMLSR operation. A STA MLD that supports EMLSR operation may be referred to as an EMLSR STA MLD. A STA affiliated with an EMLSR STA MLD may be referred to as an EMLSR STA. An AP MLD may support MLSR operation or EMLSR operation. An AP MLD that supports EMLSR operation may be referred to as an EMLSR AP MLD. An AP affiliated with an EMLSR AP MLD may be referred to as an EMLSR AP. In the present disclosure, an EMLSR MLD may refer to an EMLSR STA MLD and/or an EMLSR AP MLD, a STA MLD may refer to an EMLSR STA MLD that supports EMLSR operation, and an AP MLD may refer to an EMLSR AP MLD that supports EMLSR operation.

Among APs affiliated with an AP MLD 1, an AP operating on a first link may be referred to as an AP 1-1 (e.g., the first AP), and an AP operating on a second link may be referred to as an AP 1-2 (e.g., the second AP). Among STAs affiliated with a STA MLD 1, a STA operating on the first link may be referred to as a STA 1-1 (e.g., the first STA), and a STA operating on the second link may be referred to as a STA 1-2 (e.g., the second STA).

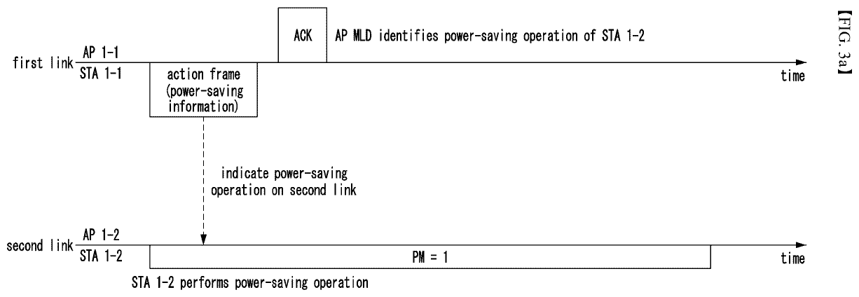

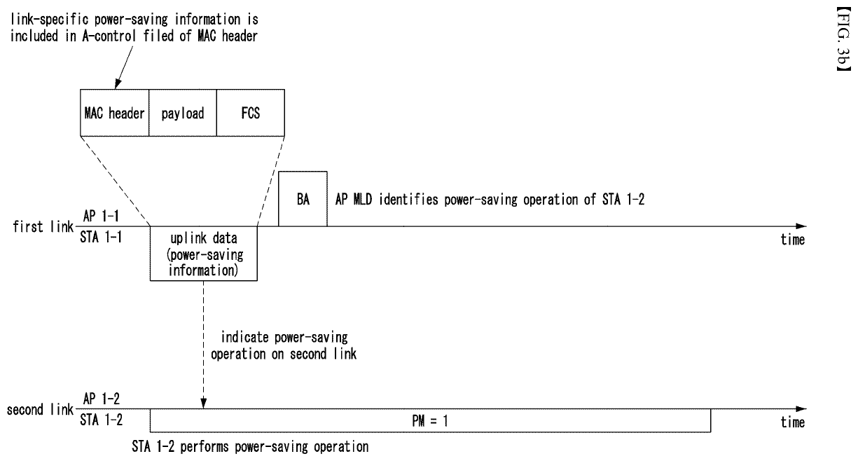

FIG. 3A is a timing diagram illustrating a first exemplary embodiment of a method for configuring a power-saving operation in a wireless LAN supporting EMLSR operation, and FIG. 3B is a timing diagram illustrating a second exemplary embodiment of a method for configuring a power-saving operation in a wireless LAN supporting EMLSR operation.

As shown in FIG. 3A and FIG. 3B, a STA MLD may transmit an action frame (e.g., extremely high throughput (EHT) action frame), which includes power-saving information, to an AP MLD. The AP MLD may receive the action frame from the STA MLD and identify the power-saving information included in the action frame. Fields, subfields, information elements, and/or indicator bits included in the action frame may represent the power-saving information. Alternatively, the STA MLD may transmit a data frame (e.g., uplink data frame) or a quality of service (QOS) Null frame that includes power-saving information to the AP MLD. The AP MLD may receive the data frame or QoS Null frame from the STA MLD and identify the power-saving information included in the data frame or QoS Null frame. The power-saving information may be included in an A-control form of a high throughput (HT) control field in a MAC header of the data frame or QoS Null frame. In other words, an A-control field of the HT control field in the MAC header included in the data frame or QOS Null frame may include the power-saving information. The A-control field may be a variant of the HT control field.

Power-saving information transmitted on a first link may be power-saving information for a second link. Power-saving information transmitted on the second link may be power-saving information for the first link. The power-saving information may include link-specific power-saving information. For example, the power-saving information may include information indicating whether a power-saving operation is performed on the first link and information indicating whether a power-saving operation is performed on the second link. In other words, the power-saving information transmitted by the STA MLD on one of the first link and the second link may include information indicating whether a power-saving operation is performed on the first link and information indicating whether a power-saving operation is performed on the second link. To indicate the link-specific power-saving information, the power-saving information may include a link bitmap and/or a link indicator. The link indicator may be a link ID.

The action frame (e.g., EHT action frame), data frame, and QoS Null frame that include power-saving information may be referred to as power-saving indication frames. For example, a STA MLD 1 (e.g., STA 1-1) may transmit a power-saving indication frame indicating the power-saving operation of the second link (e.g., power-saving mode, power-saving state) to an AP MLD 1 (e.g., AP 1-1) on the first link. The power-saving indication frame transmitted by the STA MLD 1 (e.g., STA 1-1) on the first link may include information indicating that the STA MLD 1 (e.g., STA 1-2) performs the power-saving operation on the second link. The power-saving indication frame may include a power-saving mode (PM). The PM set to a first value (e.g., 0) may indicate that a power-saving operation is not performed. The PM set to a second value (e.g., 1) may indicate that a power-saving operation is performed. If a power-saving operation is not performed on the second link, the STA 1-2 may always operate in an awake state. If a power-saving operation is performed on the second link, the STA 1-2 may operate in either an awake state or a doze state.

The AP MLD 1 may receive the power-saving indication frame from the STA MLD 1 on the first link, and based on the information included in the power-saving indication frame, the AP MLD 1 may determine that the STA MLD 1 performs the power-saving operation on the first link and/or the second link. In this case, the AP MLD 1 may perform communication (e.g., downlink communication) for the STA MLD 1, considering the power-saving operation of the STA MLD 1. The downlink communication of the AP MLD 1 may include a bufferable unit (BU) transmission operation, an automatic power save delivery (APSD) transmission operation, etc. of the AP MLD 1.

When the STA MLD 1 performs a power-saving operation, an EMLSR operation may be modified or suspended. The STA MLD 1 may be an EMLSR STA MLD that performs EMLSR operations on both the first and second links. In other words, both the first link and the second link may be EMLSR links. The STA MLD 1 may transmit a power-saving indication frame that includes information indicating that the STA MLD 1 performs a power-saving operation on the second link to the AP MLD 1 on the first link. The AP MLD 1 may receive the power-saving indication frame from the STA MLD 1, and based on the information included in the power-saving indication frame, the AP MLD 1 may determine that the STA 1-2 performs a power-saving operation on the second link. Accordingly, the AP MLD 1 may perform a BU storing operation and/or APSD operation for the STA 1-2.

Additionally, the AP MLD 1 may modify the EMLSR operation (e.g., EMLSR operation for the STA MLD 1). In other words, the AP MLD 1 may determine that the STA MLD 1 does not performing the EMLSR operation. In this case, the AP MLD 1 may transmit a data frame (e.g., downlink frame) to the STA MLD 1 on the first and/or second link without transmitting an initial control frame (e.g., multi-user request to send (MU-RTS) trigger frame or buffer status report poll (BSRP) trigger frame).

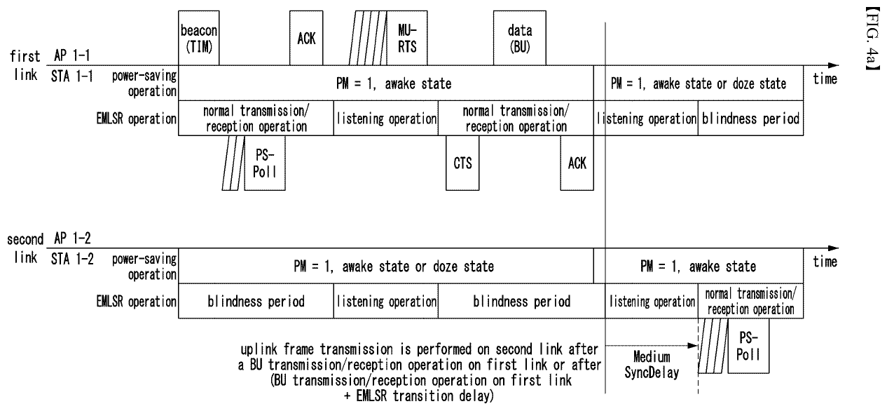

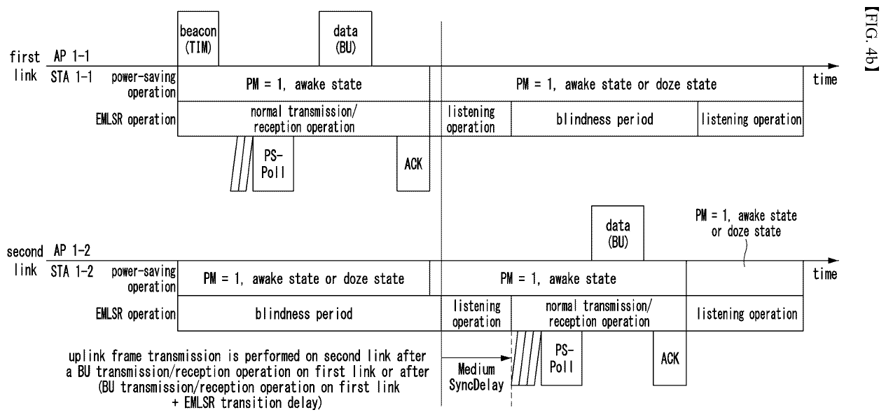

FIG. 4A is a timing diagram illustrating a first exemplary embodiment of a downlink communication method during a power-saving operation of an EMLSR MLD, and FIG. 4B is a timing diagram illustrating a second exemplary embodiment of a downlink communication method during a power-saving operation of an EMLSR MLD.

As shown in FIG. 4A and FIG. 4B, a STA MLD 1 may perform a power-saving operation on multiple links. Each STA affiliated with the STA MLD 1 may operate in an awake state for transmitting and receiving frames. In other words, the STA may operate in the awake state during a frame transmission and reception period. Outside of the frame transmission and reception period, the STA may operate in a doze state or awake state as needed. In the awake state, the STA (e.g., STA MLD) may be able to transmit and receive frames. In the doze state, the STA (e.g., STA MLD) may not be able to transmit or receive frames.

The STA MLD 1 may perform a power-saving operation on the first and/or second link. The STA MLD 1 may operate in the awake or doze state according to a specific periodicity to receive a beacon frame. The STA MLD 1 may receive a beacon frame from the AP MLD 1 on the first link, and identify a traffic indication map (TIM) included in the beacon frame. Based on the TIM, the STA MLD 1 may determine that there is downlink traffic (e.g., BU) for the STA MLD 1 to receive on the first and/or second link. If there is a BU to be received by the STA MLD 1 on the first link, the STA 1-1 of the STA MLD 1 may transmit a power-saving (PS)-Poll frame to the AP 1-1. The PS-Poll frame of the STA 1-1 may be transmitted to indicate that the STA 1-1 wishes to receive the BU on the first link.

The STA MLD 1 may perform EMLSR operations on both the first link and the second link, and the first link and the second link may be EMLSR links.

In the exemplary embodiment shown in FIG. 4A, the AP 1-1 may receive the PS-Poll frame from the STA 1-1 and transmit a reception response frame to the STA 1-1 in response to the PS-Poll frame. In the present disclosure, a reception response frame may be an acknowledgment (ACK) frame or a block ACK (BA) frame. The STA 1-1 may receive the reception response frame for the PS-Poll frame from the AP 1-1. Upon receiving the reception response frame of the AP 1-1, the STA MLD 1 may perform a listening operation on both the first link and the second link. The STA MLD 1 may be an EMLSR STA MLD. The STA MLD 1 may perform the listening operation on a link on which the PS-Poll frame has been transmitted (e.g., the first link) until a reception operation for at least one BU starts. The listening operation may be performed to receive an initial control frame and/or data frame.

During the listening operation, which is performed until the BU reception operation starts, the STA MLD 1 may refrain from transmitting an uplink frame (e.g., PS-Poll frame, data frame, etc.) to the AP MLD 1 on the other link (e.g., the second link). After transmitting the reception response frame for the PS-Poll frame of the STA MLD 1 (e.g., STA 1-1), the AP MLD 1 may initiate an EMLSR transmission procedure for BU transmission by transmitting an initial control frame (e.g., MU-RTS trigger frame) on the link on which the PS-Poll frame has been received (e.g., the first link). The initial control frame may be used for the EMLSR operation. The STA 1-1 may perform the listening operation on the first link to receive the initial control frame and/or data frame, and the STA 1-2 may perform the listening operation on the second link to receive the initial control frame and/or data frame.

The STA 1-1 may receive the initial control frame (e.g., MU-RTS trigger frame) from the AP 1-1 and transmit a clear to send (CTS) frame to the AP 1-1 after a short inter-frame space (SIFS) from a reception time of the initial control frame. The AP 1-1 may receive the CTS frame from the STA 1-1 and transmit the BU (e.g., data frame including the BU) to the STA 1-1 after a SIFS from a reception time of the CTS frame. The STA 1-1 may receive the BU from the AP 1-1 and transmit a reception response frame for the BU to the AP 1-1 after a SIFS from a reception time of the BU. The AP 1-1 may receive the reception response frame for the BU from the STA 1-1.

Transmission of an uplink frame (e.g., PS-Poll frame, data frame, etc.) on the other link (e.g., the second link) may be performed after completion of the BU transmission/reception operation on the first link. The BU transmission/reception operation may include the transmission/reception operation of the reception response frame for the BU. Alternatively, the transmission of an uplink frame on the other link (e.g., the second link) may be possible after an EMLSR transition delay from a completion time of the BU transmission/reception operation on the first link. The EMLSR transition delay may be applied after ‘aSIFSTime+aSlotTime+aRxPHYStartDelay’ from the completion time of the BU transmission/reception operation on the first link. In other words, the transmission of an uplink frame on the other link may be possible after ‘aSIFSTime+aSlotTime+aRxPHYStartDelay+EMLSR transition delay’ from the completion time of the BU transmission/reception operation on the first link.

Since the STA MLD 1 is an EMLSR STA MLD, the STA MLD 1 may refrain from performing a transmission operation of an uplink frame (e.g., PS-Poll frame, data frame, etc.) on the second link until the BU is received on the first link on which the PS-Poll frame has been transmitted. The AP 1-1 of the AP MLD 1 may perform the BU transmission operation after transmitting the initial control frame (e.g., MU-RTS trigger frame) to the STA 1-1. The STA MLD 1 may transition a state of the first link from the listening state to a normal state, and may receive the BU from the AP MLD 1 in the normal state. In the listening state, the STA MLD 1 may perform the listening operation, and in the normal state, the STA MLD 1 may perform a normal transmission/reception operation. Transitioning the state of the first link to the listening state or the normal state may mean that the state (e.g., operation state) of the STA 1-1 operating on the first link transitions to the listening state or the normal state. Transitioning the state of the second link to the listening state or the normal state may mean that the state (e.g., operation state) of the STA 1-2 operating on the second link transitions to the listening state or the normal state.

The STA 1-1 may transmit a reception response frame (e.g., ACK frame or BA frame) for the BU to the AP 1-1. After the reception operation of the BU is completed on the first link, the STA MLD 1 may transition the state of the second link to the listening state or the normal state. From a time when the state of the second link transitions to the listening state or the normal state, the STA 1-2 may perform a channel sensing operation without transmitting a frame for a duration of a MediumSyncDelay time. MediumSyncDelay may be referred to as a medium synchronization delay, medium delay, or synchronization delay. The MediumSyncDelay time may be a timer. If a network allocation vector (NAV) is set within the MediumSyncDelay timer, the MediumSyncDelay timer may be released. After the MediumSyncDelay time, the STA 1-2 may transmit a PS-Poll frame to the AP 1-2 to receive a BU. The AP 1-2 may receive the PS-Poll frame from the STA 1-2 and transmit a data frame including the BU to the STA 1-2. The STA 1-2 may receive the data frame from the AP 1-2.

Alternatively, after the MediumSyncDelay time, the STA 1-2 may transmit an uplink frame (e.g., data frame) to the AP 1-2. The AP 1-2 may receive the uplink frame from the STA 1-2 and transmit a reception response frame for the uplink frame to the STA 1-2. The STA 1-2 may receive the reception response frame for the uplink frame from the AP 1-2. As another method, the STA 1-2 may transmit an RTS frame to the AP 1-2 within the MediumSyncDelay time. The AP 1-2 may receive the RTS frame from the STA 1-2 and transmit a CTS frame to the STA 1-2 in response to the RTS frame. Upon receiving the CTS frame from the AP 1-2, the STA 1-2 may transmit an uplink frame (e.g., PS-Poll frame, data frame, etc.) to the AP 1-2.

In the embodiment shown in FIG. 4B, the STA 1-1 may transmit a PS-Poll frame to the AP 1-1. The AP 1-1 may receive the PS-Poll frame from the STA 1-1 and transmit the BU (e.g., data frame including the BU) to the STA 1-1 in response to the PS-Poll frame. The STA 1-1 may receive the BU from the AP 1-1 and transmit a reception response frame for the BU to the AP 1-1. When the reception operation of the BU is completed on the first link, the STA MLD 1 may transition the state of the second link to the listening state or the normal state. In other words, the STA 1-2 may perform a listening operation or normal transmission/reception operation.

The STA 1-2 may perform a channel sensing operation without transmitting a frame for the duration of the MediumSyncDelay time from a time when the state of the second link transitions to the listening state or the normal state. After the MediumSyncDelay time, the STA 1-2 may transmit a PS-Poll frame to the AP 1-2 to receive a BU. The AP 1-2 may receive the PS-Poll frame from the STA 1-2 and transmit a data frame including the BU to the STA 1-2. The STA 1-2 may receive the data frame from the AP 1-2.

Alternatively, after the MediumSyncDelay time, the STA 1-2 may transmit an uplink frame (e.g., data frame) to the AP 1-2. The AP 1-2 may receive the uplink frame from the STA 1-2 and transmit a reception response frame for the uplink frame to the STA 1-2. The STA 1-2 may receive the reception response frame for the uplink frame from the AP 1-2. As another method, the STA 1-2 may transmit an RTS frame to the AP 1-2 within the MediumSyncDelay time. The AP 1-2 may receive the RTS frame from the STA 1-2 and transmit a CTS frame to the STA 1-2 in response to the RTS frame. If the CTS frame is received from the AP 1-2, the STA 1-2 may transmit an uplink frame (e.g., PS-Poll frame, data frame, etc.) to the AP 1-2.

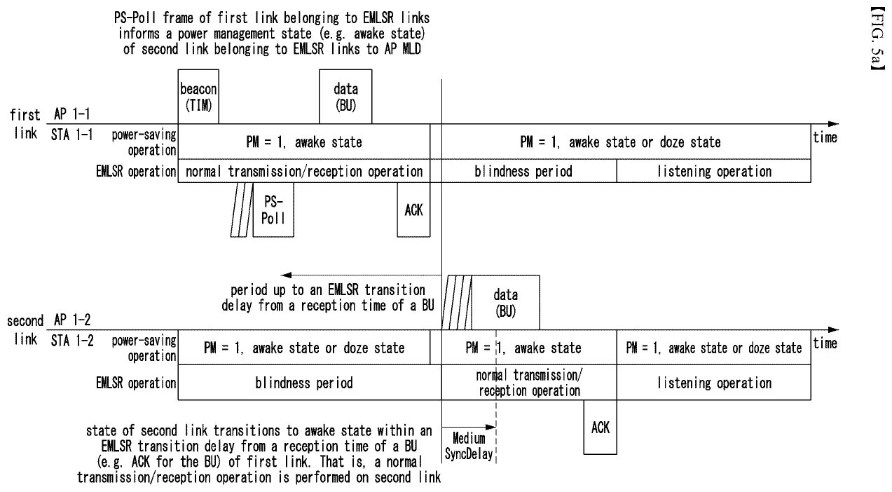

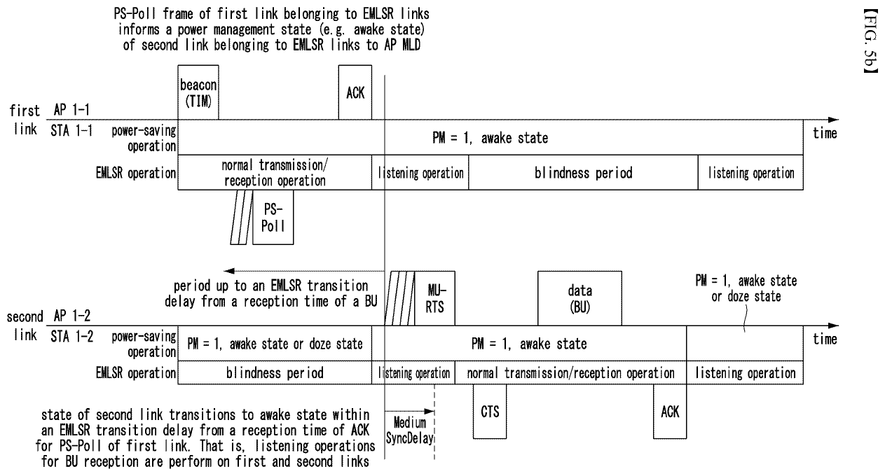

FIG. 5A is a timing diagram illustrating a third exemplary embodiment of a downlink communication method during a power-saving operation of an EMLSR MLD, and FIG. 5B is a timing diagram illustrating a fourth exemplary embodiment of a downlink communication method during a power-saving operation of an EMLSR MLD.

As shown in FIG. 5A and FIG. 5B, a STA MLD 1 may perform a power-saving operation on multiple links. Each STA affiliated with the STA MLD 1 may operate in an awake state for transmitting and receiving frames. In other words, the STA may operate in the awake state during a frame transmission and reception period. Outside of the frame transmission and reception period, the STA may operate in a doze state or awake state as needed. In the awake state, the STA (e.g., STA MLD) may be able to transmit and receive frames. In the doze state, the STA (e.g., STA MLD) may not be able to transmit or receive frames.

The STA MLD 1 may perform EMLSR operations on both the first link and the second link, and the first link and the second link may be EMLSR links.

The STA MLD 1 may perform a power-saving operation on the first link and/or the second link. The STA MLD 1 may operate in an awake or doze state according to a specific periodicity to receive a beacon frame. The STA MLD 1 may receive a beacon frame from the AP MLD 1 on the first link, and identify a TIM and/or a multi-link traffic indication element included in the beacon frame. The TIM may be a bitmap indicating association identifiers (AIDs). The multi-link traffic indication element may be a link bitmap associated with an AID corresponding to a bit set to 1 in the TIM. The link bitmap may be configured for the AID. Based on the TIM and/or multi-link traffic indication element, the STA MLD 1 may recognize that downlink traffic (e.g., BU) to be received by the STA MLD 1 is present on the first link and/or the second link. If there is a BU to be received by the STA MLD 1 on the first link, the STA 1-1 of the STA MLD 1 may transmit a PS-Poll frame to the AP 1-1. The PS-Poll frame of the STA 1-1 may be transmitted to notify that the STA MLD (e.g., STA 1-1 and STA 1-2) wishes to receive the BU on multiple links (e.g., the first link and the second link).

In other words, the PS-Poll frame transmitted on the first link belonging to the EMLSR links may indicate not only a power management state (e.g., awake state) of the first link but also a power management state (e.g., awake state) of the other link (e.g., the second link) belonging to the EMLSR links. The power management state may refer to the operation state of the STA. The state of the first link being in the awake state may mean that the STA 1-1 is able to receive a BU on the first link. The state of the second link being in the awake state may mean that the STA 1-2 is able to receive a BU on the second link. The PS-Poll frame that the STA MLD 1 (e.g., STA 1-1) transmits to the AP MLD 1 (e.g., AP 1-1) may be a conventional PS-Poll frame used in the wireless LAN. Alternatively, the PS-Poll frame that the STA MLD 1 (e.g., STA 1-1) transmits to the AP MLD 1 (e.g., AP 1-1) may be a multi-link (ML) PS-Poll frame indicating multiple links. As another method, the PS-Poll frame transmitted on the first link may indicate PM bit(s) of the first link and/or the second link. For example, the PS-Poll frame may indicate a PM bit of the second link. If the PM bit is set to 0, the STA 1-2 may always operate in the awake state on the second link. If the PM bit is set to 1, the STA 1-2 may operate in either the awake state or the doze state on the second link.

In the exemplary embodiment shown in FIG. 5A, the STA 1-1 may transmit a PS-Poll frame to the AP 1-1. The AP 1-1 may receive the PS-Poll frame from the STA 1-1. Upon receiving the PS-Poll frame from the STA 1-1, the AP 1-1 may determine that the STA 1-1 is able to receive the BU on multiple links (e.g., the first link and the second link). The AP 1-1 may transmit the BU (e.g., data frame including the BU) to the STA 1-1 in response to the PS-Poll frame. The STA 1-1 may receive the BU from the AP 1-1 and transmit a reception response frame for the BU to the AP 1-1.

When the reception operation of the BU is completed on the first link, the STA 1-2 of the STA MLD 1 may operate in the awake state on the second link during a transition delay time (e.g., EMLSR transition delay period) from a completion time of the reception operation of the BU on the first link to receive a BU on the second link. The EMLSR transition delay may be applied after ‘aSIFSTime+aSlotTime+aRxPHYStartDelay’ from the completion time of the BU transmission/reception operation on the first link. In other words, transmission of an uplink frame on the other link may be possible after ‘aSIFSTime+aSlotTime+aRxPHYStartDelay+EMLSR transition delay’ from the completion time of the BU transmission/reception operation on the first link.

After the completion time of the BU reception operation on the first link, the STA MLD 1 may transition the state of the second link to the normal state. The state of the STA 1-2 (e.g., operation state) may transition to the normal state, and the STA 1-2 operating in the normal state may perform a channel sensing operation without transmitting a frame during the MediumSyncDelay period. The MediumSyncDelay time may be a timer. If a NAV is set within the MediumSyncDelay timer, the MediumSyncDelay timer may be released.

The STA 1-2 may receive the BU from the AP 1-2 on the second link without an initial control frame. Here, the AP 1-2 may transmit the BU on the second link after the EMLSR transition delay time from a reception time of the reception response frame of the STA 1-1. As another method, the STA 1-2 may receive an initial control frame (e.g., MU-RTS trigger frame) from the AP 1-2 on the second link. Here, the AP 1-2 may transmit the initial control frame on the second link after an EMLSR transition delay time from a reception time of the reception response frame of the STA 1-1. The STA 1-2 may transmit a response frame (e.g., CTS frame) to the AP 1-2 in response to the initial control frame and receive the BU from the AP 1-2. The STA 1-2 may transmit a reception response frame for the BU to the AP 1-2.

In the exemplary embodiment shown in FIG. 5B, the STA 1-1 may transmit a PS-Poll frame to the AP 1-1. The AP 1-1 may receive the PS-Poll frame from the STA 1-1. Upon receiving the PS-Poll frame of the STA 1-1, the AP 1-1 may determine that the STA MLD 1 (e.g., STA 1-1 and STA 1-2) is able to receive a BU on multiple links (e.g., the first link and the second link). The AP 1-1 may transmit a reception response frame for the PS-Poll frame to the STA 1-1. The STA 1-2 of the STA MLD 1 may transition to the awake state within the EMLSR transition delay time from a reception time of the reception response frame from the AP 1-1. After the completion of the PS-Poll frame transmission operation and/or the reception response frame reception operation for the PS-Poll frame on the first link, the STA MLD 1 may perform a listening operation on the first and second links to receive a BU on both links. In other words, the STA 1-1 may operate in the listening state on the first link, and STA 1-2 may operate in the listening state on the second link.

The STA 1-2 may perform a channel sensing operation without transmitting a frame during the MediumSyncDelay time from a time of transitioning to the listening state on the second link. The MediumSyncDelay time may be a timer. If a NAV is set within the MediumSyncDelay timer, the MediumSyncDelay timer may be released. The AP 1-2 of the AP MLD 1 may transmit an initial control frame (e.g., MU-RTS trigger frame) to the STA 1-2. Here, the AP 1-2 may transmit the initial control frame on the second link after an EMLSR transition delay from a reception time of the reception response frame of the STA 1-1. The STA 1-2 may receive the initial control frame from the AP 1-2. Upon receiving the initial control frame from the AP 1-2, the state (e.g., operation state) of the STA 1-2 may transition from the listening state to the normal state. The STA 1-2 may transmit a response frame (e.g., CTS frame) to the AP 1-2 in response to the initial control frame. The AP 1-2 may receive the CTS frame from the STA 1-2 and transmit a BU to the STA 1-2. The STA 1-2 may receive the BU from the AP 1-2 and transmit a reception response frame for the BU to the AP 1-2. The AP 1-2 may receive the reception response frame for the BU from the STA 1-2.

After receiving the BU on the second link, the STA MLD 1 may perform a listening operation on both the first link and the second link to receive an additional BU from the AP MLD 1. In other words, the STA 1-1 may operate in the listening state on the first link, and the STA 1-2 may operate in the listening state on the second link.

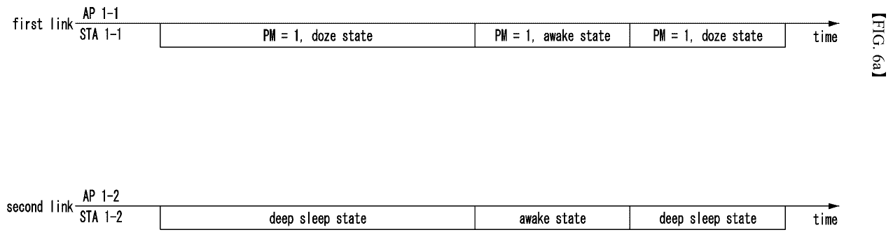

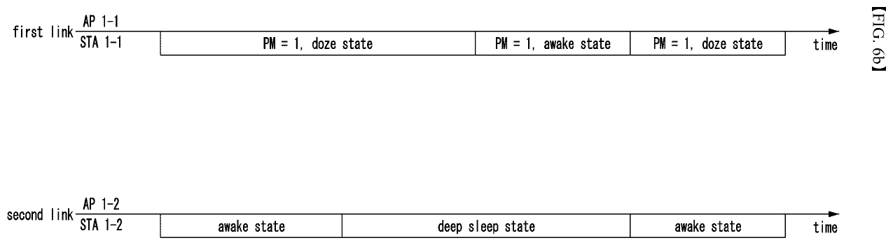

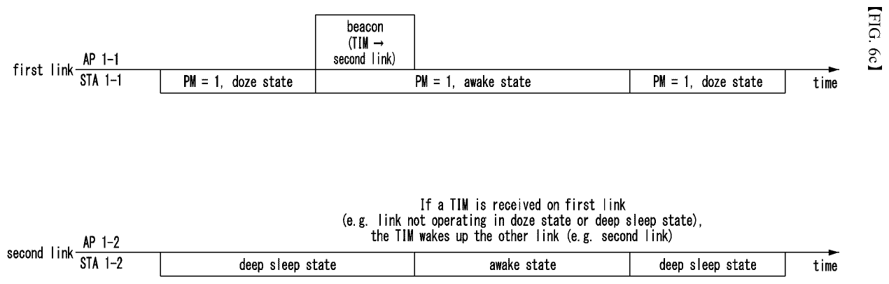

FIG. 6A is a timing diagram illustrating a first exemplary embodiment of a power-saving operation of an EMLSR MLD, FIG. 6B is a timing diagram illustrating a second exemplary embodiment of a power-saving operation of an EMLSR MLD, and FIG. 6C is a timing diagram illustrating a third exemplary embodiment of a power-saving operation of an EMLSR MLD.

As shown in FIGS. 6A to 6C, STA(s) affiliated with a STA MLD 1 may operate in a deep sleep state. The STA operating in the deep sleep state may not receive a beacon frame. For example, if the STA 1-2 operates in the deep sleep state on the second link, the STA 1-2 may not perform a reception operation of beacon frames on the second link. In the deep sleep state, the STA 1-2 may not perform communication. Power consumption in the deep sleep state may be lower than power consumption in the doze state. When a link indication is received on a link other than the second link (e.g., the first link) or when an uplink frame is transmitted on a link other than the second link (e.g., the first link), the state (e.g., operation state) of the STA 1-2 on the second link may transition from the deep sleep state to the awake state. The STA 1-2 operating in the awake state on the second link may perform transmission and reception operations of frames.

A frame including information on a power management state of each STA affiliated with the STA MLD may be transmitted. The power management state may represent a power-saving level. The information on the power management state may be included in an A-control form of a HT control field in a MAC header of a frame. In other words, an A-control field of the HT control field in the MAC header of the frame may include the information on the power management state. The power management state may be represented by power-saving level bits (e.g., additional power-saving level bits). The power-saving level bits may be 2 bits and may be set as shown in Table 1 below.

TABLE 1

| Power-saving | |
|---|---|
| level bits | Operation |
| 00 | No power-saving operation is performed |
| 01 | Normal power-saving operation (e.g., awake state |
| | and/or doze state) is performed |
| 10 | Deep sleep state is supported. |
| | For example, additional power-saving operation (e.g., |
| | awake state and/or deep sleep state) is performed |
| 11 | Awake state is not supported |

The power-saving level may refer to a level of the power-saving operation. At the first power-saving level (e.g., level 1 of the power-saving operation), a STA (e.g., STA MLD) may not perform a power-saving operation. At the second power-saving level (e.g., level 2 of the power-saving operation), a STA may operate in the awake state or doze state. At the third power-saving level (e.g., level 3 of the power-saving operation), the STA may operate in the awake state or deep sleep state. At the fourth power-saving level (e.g., level 4 of the power-saving operation), a STA may not support the awake state. The information on the power-saving level (e.g., power-saving level bits) may be included in the power-saving indication frame (e.g., action frame, data frame) in the exemplary embodiments of FIG. 3A and/or FIG. 3B. The same power-saving level may be applied to multiple links. Alternatively, different power-saving levels may be applied to multiple links. For example, the second power-saving level may be applied on the first link, and the third power-saving level may be applied on the second link.

In the exemplary embodiment of FIG. 6A, link-specific power-saving states of the STA MLD 1 may be synchronized. If the STA MLD 1 is an EMLSR STA MLD, the STA MLD 1 may include a single radio device. In this case, when the power-saving states are synchronized across the links (e.g., EMLSR links), the effect of power saving may increase. The power-saving states of the STA 1-1 and STA 1-2 affiliated with the STA MLD 1 may be synchronized. The STA 1-1 may operate in the doze state or the awake state. While the STA 1-1 is operating in the doze state, the STA 1-2 may operate in the deep sleep state (or in the doze state). A start time and/or end time of a period in which the STA 1-1 operates in the doze state may be the same as a start time and/or end time of a period in which the STA 1-2 operates in the deep sleep state. While the STA 1-1 is operating in the awake state, the STA 1-2 may also operate in the awake state. A start time and/or end time of a period in which the STA 1-1 operates in the awake state may be the same as a start time and/or end time of a period in which the STA 1-2 operates in the awake state.

The STA MLD 1 may transition between the power-saving states according to a specific periodicity (e.g., a specific time periodicity). For example, the STA 1-1 may perform the transition ‘doze state→awake state’ and/or ‘awake state→doze state’ according to the specific periodicity. The STA 1-2 may perform the transition ‘deep sleep state→awake state’ and/or ‘awake state→deep sleep state’ according to the specific periodicity. The specific periodicity may be a pre-agreed periodicity between the STA MLD 1 and AP MLD 1. The specific periodicity may be a beacon frame periodicity. Alternatively, the specific periodicity may be a multiple of the beacon frame periodicity.

In the exemplary embodiment of FIG. 6B, link-specific power-saving states of the STA MLD 1 may not be synchronized. The power-saving states of the STA 1-1 and STA 1-2 affiliated with the STA MLD 1 may not be synchronized. The power-saving level and/or transition periodicity of the power-saving state may be configured independently on each link. The power-saving level on the first link may be different from the power-saving level on the second link. The transition periodicity of the power-saving state on the first link may be different from that on the second link. For example, the STA 1-1 may perform the transition ‘doze state→awake state’ and/or ‘awake state→doze state’ according to a first periodicity. The STA 1-2 may perform the transition ‘deep sleep state→awake state’ and/or ‘awake state→deep sleep state’ according to a second periodicity. The first periodicity and/or the second periodicity may be pre-agreed periodicities between the STA MLD 1 and AP MLD 1. The first periodicity and/or the second periodicity may be a beacon frame periodicity. Alternatively, the specific periodicity may be a multiple of the beacon frame periodicity.

In the exemplary embodiment of FIG. 6C, the STA 1-1 may operate in the awake state or doze state, and the STA 1-2 may operate in the awake state or deep sleep state. When specific information (e.g., TIM included in a beacon frame) is received on the first link, the state (e.g., operation state) of the STA 1-2 on the second link may transition from the deep sleep state to the awake state. For example, the STA 1-1 of the STA MLD 1 may receive a beacon frame from the AP 1-2 and identify a TIM included in the beacon frame. If the TIM indicates the use of the second link or if the TIM indicates presence of a BU to be transmitted on the second link, the STA 1-2 of the STA MLD 1 may transition from the deep sleep state to the awake state and perform additional operations to receive the BU from the AP MLD 1 (e.g., AP 1-2). As another method, the STA MLD 1 may be referred to as an AP MLD 2, and the AP MLD 1 may be referred to as an STA MLD 2. In other words, the STA MLD 1 may operate as an AP MLD, and the AP MLD 1 may operate as a STA MLD (non-AP MLD). While the AP MLD 2 operates in the awake state on the first link, it may operate in the deep sleep or doze state on the second link. If the AP MLD 2 receives a frame from the STA MLD 2 on the first link (e.g., if the AP MLD 2 receives specific information requesting the use of the second link), the AP MLD 2 may operate in the awake state on the second link, and the AP MLD 2 and STA MLD 2 may perform communication operations on both the first link and the second link.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

1. A method of a station (STA) multi-link device (MLD), comprising:
performing a power-saving operation on a first link and a second link;
receiving a beacon frame from a first access point (AP) affiliated with an AP MLD while a first STA affiliated with the STA MLD operates in an awake state on the first link;
performing, by the first STA, first communication with the first AP on the first link based on the beacon frame; and
performing, by a second STA affiliated with the STA MLD, second communication with a second AP affiliated the AP MLD while the second STA affiliated with the STA MLD operates in the awake state on the second link after the first communication is completed.

2. The method according to claim 1, further comprising: transmitting, to the AP MLD, a first frame including information indicating that the power-saving operation is performed on the first link and information indicating that the power-saving operation is performed on the second link, on one of the first link and the second link.

3. The method according to claim 2, wherein the first frame further includes information indicating a level of the power-saving operation, an operation state of each of the first STA and the second STA is the awake state or the doze state when a first level of the power-saving operation is supported, and the operation state of each of the first STA and the second STA is the awake state or a deep sleep state when a second level of the power-saving operation is supported.

4. The method according to claim 3, wherein a level of the power-saving operation performed on the first link is different from a level of the power-saving operation performed on the second link.

5. The method according to claim 3, wherein the operation state of the first STA on the first link is synchronized with the operation state of the second STA on the second link.

6. The method according to claim 1, wherein the performing of the first communication comprises:
transmitting, by the first STA, a power-saving (PS)-Poll frame for the beacon frame to the first AP on the first link;
receiving, by the first STA, an initial control frame from the first AP on the first link;
transmitting, by the first STA, a response frame for the initial control frame to the first AP on the first link; and
receiving, by the first STA, a data frame from the first AP on the first link.

7. The method according to claim 6, wherein in order to receive the initial control frame, the first STA performs a listening operation on the first link, and the second STA performs a listening operation on the second link.

8. The method according to claim 1, wherein the performing of the first communication comprises:
transmitting, by the first STA, a PS-Poll frame for the beacon frame to the first AP on the first link; and
receiving, by the first STA, a data frame from the first AP without receiving an initial control frame on the first link.

9. The method according to claim 8, wherein the PS-Poll frame includes information indicating an operation state of the first STA on the first link and information indicating an operation state of the second STA on the second link.

10. The method according to claim 1, wherein the performing of the second communication comprises:
receiving, by the second STA, an initial control frame from the second AP on the second link;
transmitting, by the second STA, a response frame for the initial control frame to the second AP on the second link; and
receiving, by the second STA, a data frame from the second AP on the second link.

11. The method according to claim 1, wherein the performing of the second communication comprises:
transmitting, by the second STA, a PS-Poll frame to the second AP on the second link; and
receiving, by the second STA, a data frame from the second AP without receiving an initial control frame on the second link.

12. A station (STA) multi-link device (MLD) comprising a processor, wherein the processor causes the STA MLD to perform:
performing a power-saving operation on a first link and a second link;
receiving a beacon frame from a first access point (AP) affiliated with an AP MLD while a first STA affiliated with the STA MLD operates in an awake state on the first link;
performing, by the first STA, first communication with the first AP on the first link based on the beacon frame; and
performing, by a second STA affiliated with the STA MLD, second communication with a second AP affiliated the AP MLD while the second STA affiliated with the STA MLD operates in the awake state on the second link after the first communication is completed.

13. The STA MLD according to claim 12, wherein the processor further causes the STA MLD to perform: transmitting, to the AP MLD, a first frame including information indicating that the power-saving operation is performed on the first link and information indicating that the power-saving operation is performed on the second link, on one of the first link and the second link.

14. The STA MLD according to claim 13, wherein the first frame further includes information indicating a level of the power-saving operation, an operation state of each of the first STA and the second STA is the awake state or the doze state when a first level of the power-saving operation is supported, and the operation state of each of the first STA and the second STA is the awake state or a deep sleep state when a second level of the power-saving operation is supported.

15. The STA MLD according to claim 14, wherein a level of the power-saving operation performed on the first link is different from a level of the power-saving operation performed on the second link.

16. The STA MLD according to claim 12, wherein in the performing of the first communication, the processor causes the STA MLD to perform:
transmitting, by the first STA, a power-saving (PS)-Poll frame for the beacon frame to the first AP on the first link;
receiving, by the first STA, an initial control frame from the first AP on the first link;
transmitting, by the first STA, a response frame for the initial control frame to the first AP on the first link; and
receiving, by the first STA, a data frame from the first AP on the first link.

17. The STA MLD according to claim 12, wherein in the performing of the first communication, the processor causes the STA MLD to perform:
transmitting, by the first STA, a PS-Poll frame for the beacon frame to the first AP on the first link; and
receiving, by the first STA, a data frame from the first AP without receiving an initial control frame on the first link.

18. The STA MLD according to claim 17, wherein the PS-Poll frame includes information indicating an operation state of the first STA on the first link and information indicating an operation state of the second STA on the second link.

19. The STA MLD according to claim 12, wherein in the performing of the second communication, the processor causes the STA MLD to perform:
receiving, by the second STA, an initial control frame from the second AP on the second link;
transmitting, by the second STA, a response frame for the initial control frame to the second AP on the second link; and
receiving, by the second STA, a data frame from the second AP on the second link.

20. The STA MLD according to claim 12, wherein in the performing of the second communication, the processor causes the STA MLD to perform:
transmitting, by the second STA, a PS-Poll frame to the second AP on the second link; and
receiving, by the second STA, a data frame from the second AP without receiving an initial control frame on the second link.
